(19) United States
(12) Patent Application Publication
(10) Pub. No.: US 2003/0037460 A1
(43) Pub. Date: Feb. 27, 2003

(54) Clothes dryer

(76) Inventors: Sung Bae Song, Seoul (KR); Sang Wook Hong, Seoul (KR); Sang Heon Yoon, Seoul (KR); Hwan Joo Myung, Seoul (KR)

Correspondence Address: BIRCH STEWART KOLASCH & BIRCH, PO BOX 747, FALLS CHURCH, VA, 22040-0747, US

(21) Appl. No.: 10/040,641

(22) Filed: Jan. 9, 2002

(30) Foreign Application Priority Data
Aug. 22, 2001 (KR) 50755/2001

(51) Int. Cl. F26B 11/02

(52) U.S. Cl. 34/595

(57) ABSTRACT

A clothes dryer in accordance with the present invention, including a drum supported in the case rotatably, having a space for drying clothes inside, a suction duct connected to one side of the drum, to which air for drying clothes is supplied, an extension duct lengthened from the suction duct into the drum, for flowing the air supplied from the suction duct into the drum and an exhaust duct connected to the other side of the drum, for exhausting air which dried clothes to the outside of the case can dry clothes inputted into the drum uniformly by composing the dryer capable of directly transmitting heated air to the center portion of the drum, thus to improve clothes drying efficiency.

### BACKGROUND OF THE INVENTION

1. Field of the Invention

The present invention relates to a clothes dryer and particularly, to a clothes dryer capable of flowing heated air to the inside of the drum and discharging the air which dried clothes in the drum.

2. Description of the Background Art

Generally, a clothes dryer is an apparatus for automatically drying wet clothes after being washed, being installed apart from a washing machine and is classified into a dehumidifying-type and exhausting-type.

The dehumidifying-type is a method for drying clothes by condensing moisture circulating air in the drum, exhausting water generated at this time to the outside of the dryer and supplying air to the inside of a drum heating the air.

The exhausting-type is a method for drying clothes by guiding external air of the dryer to the inside of the drum after sucking and heating the air and exhausting the air to the outside of the dryer again.

FIG. 1 is a view showing an exhausting-type clothes dryer, FIG. 2 is a cross-sectional view taken along section line A-A of FIG. 1 and the conventional clothes dryer will be described as follows.

With reference to FIG. 1, the conventional clothes dryer includes a case 1 having an input opening 1a on the front surface, a door 2 for opening and closing the input opening 1a of the case 1, a drum 3 installed in the case 1 rotatably, for receiving clothes, having a plurality of baffles (not shown) protruded on the inner circumferential surface, a driving motor 4 and transmission means 5 installed in the case 1, for rotating the drum, an air circulation unit 7 for exhausting external air of the case 1 to the outside of the case 1 after flowing the air into the drum 3 and a heater 6 installed at the inlet side of the suction duct 7A of the above air circulation unit 7, for heating air flown into the drum.

The drum 3 includes a body 3A which rotates being connected to the driving motor 4 and the driving means 5 and side plates 3B and 3C combined to the body 3A at the both sides of the body 3A movably.

The body 3A has a cylindrical shape and the above pluralities of baffles are formed on the circumferential surface at the inner side as a single body.

The above side plates 3B and 3C are all formed in a circular plate shape and a suction port 3b connected with the suction duct 7A of the air circulation unit 7 is formed on the rear plate 3B and the exhaust port 3c connected with an exhaust duct of the air circulation unit 7 which will be described later is formed on the front plate 3C.

The driving motor 4 is composed of a one-direction rotary motor which rotates in the same direction and speed having the driving shaft drawn to both directions and the transmission means 5 includes a pulley 5a combined with a driving shaft at a side of the driving motor 4 and a belt 5b connected from the pulley 5a to the body 3A of the drum 3, for transmit the rotation force of the driving motor 4.

The heater 6 is installed at the inlet side of the suction duct 7A being adjacent or combined to the inlet side and conventionally, electric heater and gas heater are used.

The air circulation unit 7 includes the suction duct 7A for guiding air in the case 1 into the drum 3, the exhaust duct 7B for exhausting the air in the drum 3 to the outside of the case 1 and a fan 7C positioned at the center of the exhaust duct 7B, for flowing air.

The suction duct 7A is installed to guide air heated passing the heater 6 after the air is flown to the inside through the air circulation port 1b of the case 1 to the inside of the drum 3. The inlet is positioned or combined to the rear of the heater 6 and the outlet is installed to be connected with the suction port 3b of the drum 3.

The exhaust duct 7B has an inlet installed being connected to the suction port 3c of the drum 3 and the outlet is lengthened-installed to the outside penetrating the rear wall of the case 1.

The fan 7C is combined to a driving shaft of the other side of the driving motor 4 which is at the other side of the motor means 5 in the exhaust duct 7B and accordingly, is composed of single inlet centrifugal fans having a suction side and an exhaust side respectively.

In FIG. 1, reference numeral 3d designates a clothes input opening of the drum and F designates a filter.

The operation of the conventional clothes dryer with the above composition will be described as follows.

When a power is applied to the driving motor 4, the drum 3 is rotated by the belt 5b and clothes in the drum 3 are mixed. After the external air is heated as the fan 7C rotates, the air is supplied to the inside of the drum 3 and dries wet clothes.

Namely, when the fan 7C is operated the external air is sucked into the case 1 and the air is heated passing the heater 6 and flown to the inside of the drum 3 through the suction duct 7A and the suction port 3b. The heated air flown into the drum dries the wet clothes and then is exhausted to the outside of the case 1 through the exhaust port 3c and the exhaust duct 7B.

However, in the conventional clothes dryer, since the suction port 3b of the drum 3 is formed as a simple punched hole shape on the rear plate 3B, heated air sucked to the inner side of the drum 3 is moved to the side of the front plate 3C along the upper portion of the inner circumferential surface of the drum 3 and then exhausted. Therefore, the air can not be contacted with clothes positioned at the center portion of the drum 3 and accordingly, clothes in the drum 3 can not be dried uniformly according to the position of the clothes in the drum 3, thus to decrease clothes drying efficiency and increase time for drying clothes.

Also, in the conventional clothes dryer, when heated air is flown into the drum 3 through the suction duct 7A, it tends to be flown to the upper side but as shown in FIG. 2, since the suction port 3b formed on the rear plate 3B is narrow at the upper side and wide at the lower side, flowing resistance of air is increased and accordingly, amount of air inflow for the same cross section of the suction port 3b is decreased, thus to decrease clothes drying efficiency.

Also, in the conventional clothes dryer, as the suction duct 7A and the exhaust duct 7B are positioned at the front and rear sides of the drum 3, when comparing volume of the same case 1, the volume of the drum 3 is decreased. Since the volume of the drum 3 must be increased to dry much amount of clothes, there was a disadvantage that the whole volume of the case 1 is increased.

Also, to dry clothes efficiently, it is advantageous when the direction and speed of rotation of the drum 3 is changed irregularly but since the conventional clothes dryer described above drives the drum 3 and fan 7C simultaneously using just one driving motor 4, the fan must be rotated in a direction. Therefore, the drum 3 rotates only in a direction, thus to decrease drying efficiency.

### SUMMARY OF THE INVENTION

Therefore, the present invention provides a clothes dryer capable of improving clothes drying efficiency by uniformly drying clothes inputted into a drum composing the dryer so that heated air is directly transmitted to the center portion of the drum.

Another object of the present invention is to provide a clothes dryer capable of shortening time for drying clothes by increasing the amount of the heated air supplied into the drum.

Still another object of the present invention is to provide a clothes dryer capable of increasing amount of drying clothes by increasing the volume of the drum not increasing the size of the case.

Still another object of the present invention is to provide a clothes dryer capable of improving drying efficiency by independently driving the drum and fan and varying direction and speed of rotation.

To achieve these and other advantages and in accordance with the purpose of the present invention, as embodied and broadly described herein, there is provided a clothes dryer including a drum supported in the case rotatably, having a space for drying clothes inside, a suction duct connected to one side of the drum, to which air for drying clothes is supplied, an extension duct lengthened from the suction duct into the drum, for flowing the air supplied from the suction duct into the drum and an exhaust duct connected to the other side of the drum, for exhausting air which dried clothes to the outside of the case.

The extension duct is lengthened-installed in the longitudinal direction of the drum and the extension duct has an end portion lengthened to the center portion of the drum.

The extension duct is formed in a cylindrical shape and a plurality of air holes are formed on the circumferential and end surfaces.

The drum has two air suction ports connected to the suction duct on the rear side and the extension duct is connected to a suction port between the two suction ports.

The air suction port which is not connected to the extension duct is formed a certain distance apart from the rotation center of the drum and the air suction port which is not connected to the extension duct is formed to have larger area along from the rotation center to the outer circumferential direction.

The air suction port connected to the extension duct is positioned at the rotation center of the drum.

The drum comprises a body which rotates formed in a cylindrical form, a front plate and rear plate combined to the front and rear sides of the body, which does not rotate, an inlet portion of the exhaust duct is connected to the front plate and a suction duct and extension duct are connected to the rear plate ventilating with each other.

Here, the exhaust duct is connected at the front side of the front plate.

A fan is installed to compulsorily flowing air in the air circulative pass composed of the suction duct and exhaust duct and the fan and the drum are rotated and driven by a driving motor.

In accordance with the second embodiment of the present invention, the front plate has a cylindrical portion lengthened a certain length in the longitudinal direction of the body on the outer circumferential surface and the exhaust duct is connected to an exhaust port formed at the lower side of the cylindrical portion.

In accordance with the third embodiment of the present invention, the exhaust duct includes a first exhaust duct for exhausting air exhausted from the drum to the outside of the case and a second exhaust duct diverged from the first exhaust duct, for exhausting part of the air exhausted from the drum to the front side of the suction duct.

The fan is installed to compulsorily flow air in the air circulative pass composed of the suction duct and exhaust duct and the fan and the drum are rotated and driven by each driving motor.

Also, the clothes dryer in accordance with the present invention for achieving the above objects, includes a drum composed of a body supported rotatably in a case and a front plate and a rear plate combined to the front and rear sides of the body, which do not rotate, a suction duct connected to the rear plate of the drum, to which air for drying clothes is supplied and an exhaust duct connected to the front plate of the drum, for exhausting air which dried clothes to the outside, wherein the front plate of the said drum comprises a cylindrical portion lengthened a certain length in the longitudinal direction of the body from the outer circumferential surface, having an exhaust port at the lower portion at the same time and the said exhaust duct is connected to the exhaust port of the cylindrical portion.

Also, the clothes dryer in accordance with the present invention for achieving the above objects, includes a drum composed of a body supported rotatably in a case and a front plate and a rear plate combined to the front and rear sides of the body, which do not rotate, a suction duct connected to the rear plate of the drum, to which air for drying clothes is supplied and an exhaust duct connected to the front plate of the drum, for exhausting air which dried clothes to the outside, wherein an air suction port is formed on the rear plate of the said drum so that the suction duct is connected to the rear plate and the air suction port is formed to have larger area along from the rotation center of the drum to the outer circumferential direction.

Also, the clothes dryer in accordance with the present invention for achieving the above objects, includes a drum supported in the case rotatably, having a space for drying clothes inside, a suction duct connected to one side of the drum, to which air for drying clothes is supplied, a first exhaust duct connected to the other side of the drum for exhausting air which dried clothes to the outside of the case and a second exhaust duct diverged from the first exhaust duct, for exhausting part of the air exhausted from the drum to the front side of the suction duct.

The foregoing and other, features, aspects and advantages of the present invention will become more apparent from the following detailed description when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal sectional view showing a conventional clothes dryer;

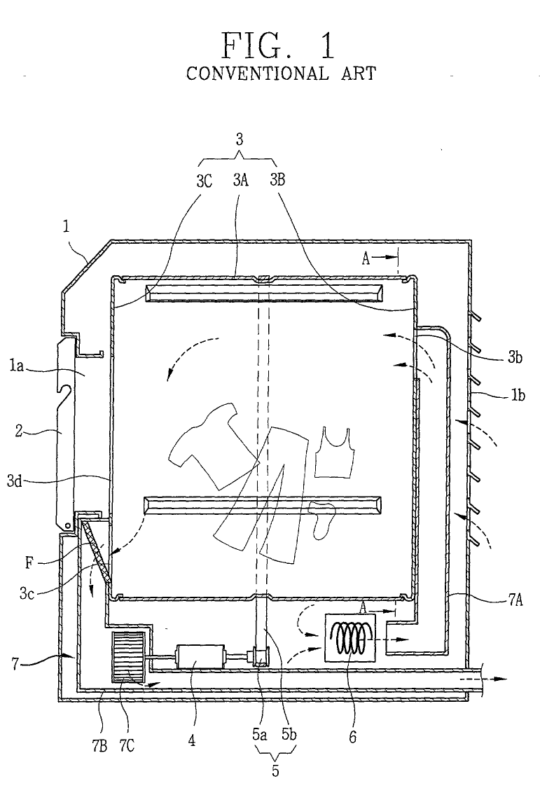

FIG. 2 is a cross-sectional view taken along section line A-A of FIG. 1 showing and a front view showing a rear plate of a drum;

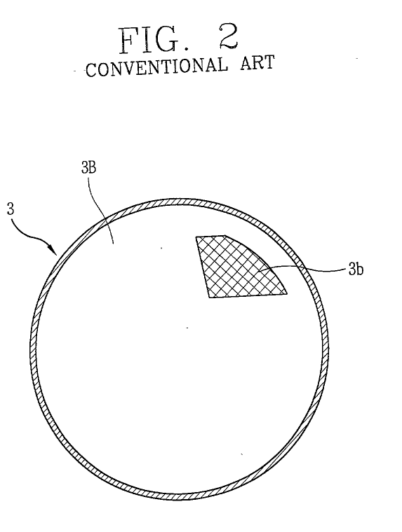

FIG. 3 is a longitudinal sectional view showing a clothes dryer in accordance with a first embodiment of the present invention;

FIG. 4 is a cross-sectional view taken along section line B-B of FIG. 3 showing and a front view showing a rear plate of a drum;

FIG. 5 is a longitudinal sectional view showing a clothes dryer in accordance with a second embodiment of the present invention;

FIG. 6 is a schematic perspective view showing a clothes dryer in accordance with a third embodiment of the present invention; and

FIG. 7 is a transverse sectional view showing an exhaust duct portion in FIG. 6.

### DETAILED DESCRIPTION OF THE PREFERRED EMBODIMENTS

Reference will now be made in detail to the preferred embodiments of the present invention, examples of which are illustrated in the accompanying drawings.

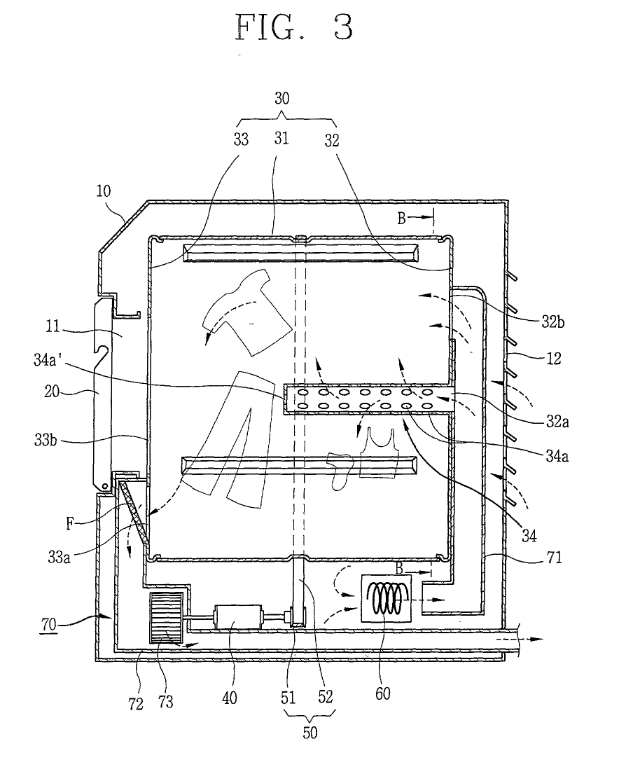

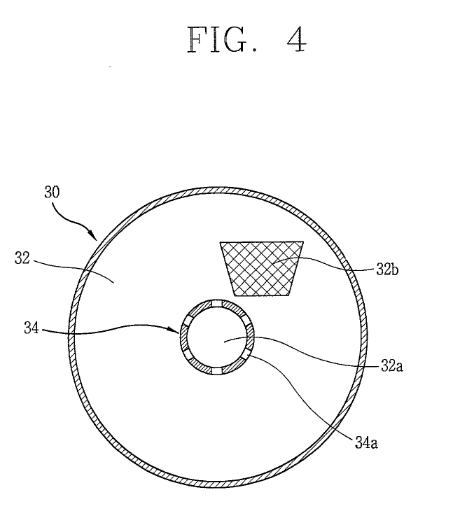

FIG. 3 is a longitudinal sectional view showing a clothes dryer in accordance with a first embodiment of the present invention and FIG. 4 is a cross-sectional view taken along section line B-B of FIG. 3 showing and a front view showing a rear plate of a drum. In FIGS. 3 and 4, reference numerals which are same as the conventional art designate the same reference numeral.

With reference to FIG. 3, the clothes dryer in accordance with the first embodiment of the present invention includes a case 10 having an input opening 11 on the front surface and air inflow holes 12 on the rear side, a door 20 for opening and closing the input opening 11 of the case 10, a drum 30 installed in the case 10 rotatably, for receiving clothes, having a plurality of baffles not shown protruded on the inner circumferential surface, a driving motor 40 positioned in the case 10, for generating a rotation force, a transmission means 50 for transmitting the rotation force of the driving motor 40 to the drum 30, an air circulation unit 70 for sucking the external air of the case 10 into the drum 3 and exhausting the air which dried clothes in the drum 30 to the outside of the case 10 and a heater 60 installed at the inlet side of the air circulation unit 70, for heating air flown into the drum.

The drum 30 includes a body 31 having a cylindrical shape, rotating being connected to the driving motor 40 and the transmission means 50 and a rear plate 32 and a front plate 33 combined to both side surfaces of the body 31 capable of performing relative movement.

With reference to FIG. 4, the rear plate 32 is formed in the form of a circular plate and the first and second air suction ports 32a and 32b are formed to be connected to the suction duct 71 of the air circulative device 70 on the plate. An extension duct 34 lengthened into the body is positioned being assembled thereafter or formed as a single body when it is manufactured at the second air suction port 32a.

Here, the second air suction port 32a is formed as a circular shape to be connected with the extension duct 34 and the first air suction port 23b is formed in the form of a reverse trapezoid which becomes gradually wider along from the lower portion to the upper portion so that air ascended through the suction duct 72 can be flown into the drum 30 through the first half portion (of the air suction port).

Also, it is desirable that one (the second air suction port) between the air suction ports 32a and 32b is formed at the right center portion of the rear plate 32 and the first air suction port in the other drawing is formed at the first half portion at the left and right sides or second half portion taking the point in time when clothes fall into consideration to increase drying efficiency by widening the contactive distribution with the clothes.

The extension duct 34 is lengthened-installed at the position of the rotation center of the drum 30 in the longitudinal direction of the drum.

The extension duct 34 is formed having a same diameter from the beginning to the ending and it can be formed as a cylindrical shape having the ending closed or as a cylindrical structure in the taper shape having smaller diameter gradually along from the beginning to the ending.

Also, on the circumferential and end surfaces of the extension duct 34, air holes 34a and 34a′ connected with the second air suction port 32a, for supplying air from the center portion of the drum 30 in the radial direction are radially formed regularly or irregularly. The air holes 34a can be composed varying the diameter at the extension duct 34a taking the clothes drying process and clothes falling portion into consideration.

The front plate 33 is formed in the shape of a circular plate as the rear plate 32 and an air exhaust port 33a connected to the exhaust duct 72 of the air circulative device 70 and the drum is formed on the front plate.

The driving motor 40 is a one-direction rotary motor which rotates in the same direction and at same speed, having driving shafts led in the both directions. A driving shaft is combined with the transmission means 50 for rotating the drum 30 and the other driving shaft is combined with a fan 73 of the air circulation unit 70.

The transmission means 50 includes a pulley 51 combined with the driving shaft at a side of the driving motor 40 and a belt 52 connected from the pulley 51 to the body 31 of the drum 30, for transmit the rotation force of the driving motor 40 to the body 31.

The heater 60 is formed as an electric heater or gas heater and installed at the inlet side of the suction duct.

The air circulation unit 70 includes the suction duct 71 to flow the air flown through the inlet port 12 of the case 10 into the drum, the exhaust duct 72 connected to exhaust the air in the drum 30 to the outside, a suction increasing duct 74 installed on a side surface of the exhaust duct 72, for compulsorily supplying air from the inside of the case 10 to the inlet side of the heater 60 and a double inlet fan 73 installed at the center of the exhaust duct 72 and the suction increasing duct 74, for sucking and exhausting the air to the both directions.

The inlet portion of the suction duct 71 has the inlet portion positioned at the rear of the heater 60 and the outlet portion installed connected to the suction ports 32a and 32b of the drum 30.

Also, in the inlet portion of the suction duct 71, since the outlet portion must be connected with the respective air suction ports 32a and 32b of the drum 30, the inlet portion in the present embodiment can be formed as a single pipe or the outlet portion can be formed as a plurality of diverged pipes with the same number of the air suction ports 32a and 32b and the inlet and outlet ports can be formed as each single pipe.

The exhaust duct 72 has an inlet portion connected to the exhaust port 33a of the drum 30 and an outlet portion expanded-installed to the outside penetrating the case 10.

Here, the exhaust duct 72 is combined to the air exhaust port 33a at the front side of the front plate 33.

The fan 73 is combined to the driving shaft of the other side of the driving motor 40 so that it rotates in the same direction and speed as the transmission means 50.

Reference numeral F designates a filter for filtering air discharged from the drum 30.

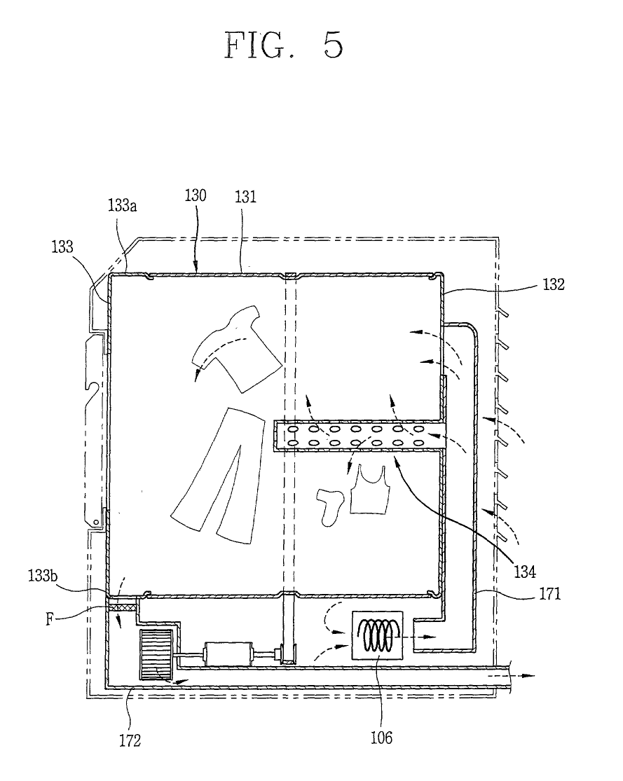

FIG. 5 is a longitudinal sectional view showing the clothes dryer in accordance with the second embodiment of the present invention.

The clothes dryer in accordance with the second embodiment of the present invention has the same composition as the first embodiment but the compositions of a rear plate 133 of a drum 130 and an exhaust duct 172 are different.

Namely, a front plate 133 composing the drum 130 has a cylindrical portion 133a lengthened a certain length in the longitudinal direction of a body 131 on the outer circumferential surface and a exhaust port 133b connected to the exhaust duct 72 at the lower side of the cylindrical portion 133a.

At the center of the rear plate 132 of the drum 130, an extension duct 134 is installed as in the first embodiment. The extension duct 134 and the suction duct 171 are mutually connected and a heater 106 supplies heated air.

The rear plate 132 is formed in the form of a simple circular plate taking the volume of the suction duct 171 into consideration.

The second embodiment of the present invention with the above composition is same as the above first embodiment except the parts described above.

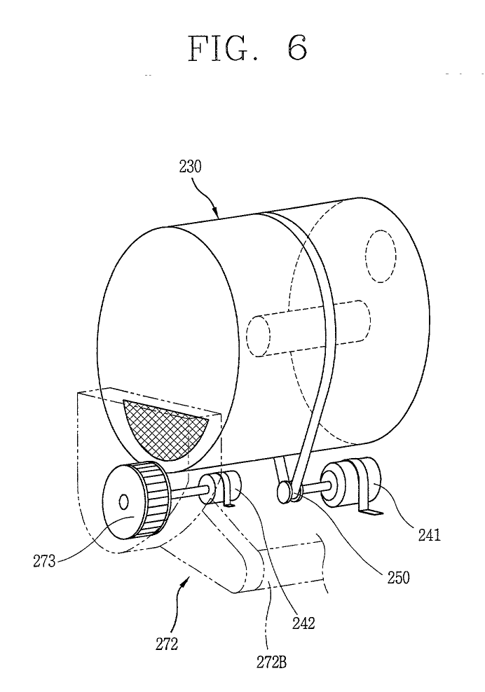

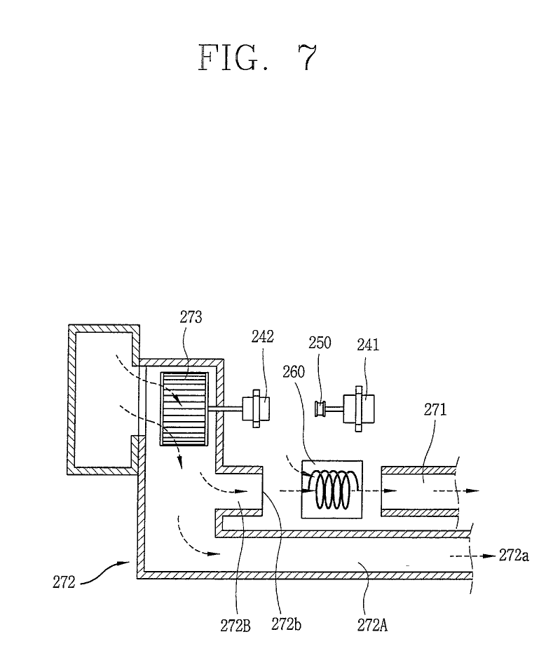

FIG. 6 is a schematic perspective view showing the clothes dryer in accordance with the third embodiment of the present invention and FIG. 7 is a transverse sectional view showing the exhaust duct portion in FIG. 6.

In the clothes dryer in accordance with the third embodiment of the present invention, an exhaust duct 272 has a plurality of exhaust ports 272a and 272b and one of the ports is composed capable of exhausting air to a heater 260 which is the inlet portion of a suction duct 271.

Namely, in the first exhaust duct 272A of the exhaust duct 272, an exhaust port 272a is positioned outside the case (not shown) and connected to exhaust air to the outside.

A second exhaust duct 272b is diverged from the first exhaust duct and positioned at the front of the heater 260 to exhaust air to the heater 260 and flow the air into the suction duct 271 again.

In the third embodiment of the present invention, the second exhaust duct 272B is positioned and part of the air which dried clothes in the drum 230 is supplied into the drum 260 through the heater 260 and suction duct 271 again, thus to reduce time for heating of air. At the same time, amount of the air flown into the suction duct 271 is increased and accordingly, amount of the air flown into the drum 30 can be increased, thus to shorten time for clothes drying.

The clothes dryer in accordance with the third embodiment of the present invention has a plurality of driving motors 241 and 242 and accordingly, it can rotary drive a fan 273 and the drum 230 independently.

Namely, in the first motor 241 among the driving motors 241 and 242, the driving shaft is combined with a transmission means 250 and rotates the drum 230. In the second motor 242, the driving shaft is combined with the fan 273 and rotates the fan.

Therefore, the driving motors 241 and 242 can control the drum 230 and the fan 273 to rotate in different direction and speed and varying the direction and speed according to the kind or amount of the clothes, thus to dry clothes more efficiently and shorten the time for drying clothes.

The clothes dryer in accordance with the third embodiment of the present invention is same as that of the first embodiment except the parts described above.

On the other hand, as described in the third embodiment, if a clutch and transmission device which can change rotation direction and speed of the motor are positioned on a driving shaft connected with the fan or transmission means in the one driving motor, the drum and fan can be controlled in the different rotation direction and speed using a driving motor without using a plurality of driving motors 241 and 242.

The operation and effect of the clothes dryer in accordance with the present invention will be described centering round the first embodiment.

With reference to FIG. 3, when a power is applied to the driving motor 40, the drum 30 mixes clothes at the inner side of the drum 30 rotating by the belt 52 and the fan 73 rotates and sucks the outer air to the inside of the case 10.

As the sucked air is heated by the heater 60, the air is flown into the drum 30 through the suction duct 71 and air suction port 32a or the suction duct 71 and the extension duct 34 and dries clothes. Then the air is exhausted to the outside of the case 10 through the air exhaust port 33a and the exhaust duct 72.

At this time, the air flown into the drum through the suction duct 71 is supplied through the air suction ports 32a and 32b positioned on the rear plate of the drum 30 and the air of the air suction port 32b not connected to the extension duct 34 mainly dries clothes at the outer side moving along the circumferential surface of the drum.

The air supplied from the air suction port 32a connected with the extension duct 34 and the air hole 34a of the extension duct 34 after passing through the air suction port 32a moves from the center of the drum to the circumferential surface and mainly dries clothes at the inner side of the drum.

Therefore, in the clothes dryer in accordance with the present invention, the heated air is supplied to the inner and outer sides of the clothes through the air suction ports 32a and 32b and accordingly, the clothes can be dried more efficiently and swiftly.

Also, if the extension duct 34 is formed in a taper shape forming the diameter smaller along from the beginning to the end in the air flowing direction, since the air can be exhausted to the ending at a certain pressure even though the air is leaked through the air hole 34a formed at the beginning portion of the extension duct 34, clothes positioned at the front and rear sides of the drum can be dried more uniformly.

Also, in case inflow amount of the heated air is increased by particularly increasing the diameter of the air hole 34a corresponding to the position where the clothes fall having different diameter of the air hole 34a of the extension duct 34.

Also, as the extension duct 34 is formed lengthened in the shaft direction of the drum 30, the clothes which rotated with the drum 30 can be prevented from being tangled and accordingly, efficiency of clothes drying can be increased.

As the air heated by the heater 60 can be supplied further to the center portion of the clothes which will be dried, since the heated air can be equally contacted to the inner side of the clothes as well as the outer side even though much amount of clothes is dried at a time, drying performance is substantially improved. Accordingly, time for clothes drying is reduced and electricity consumption can be reduced.

Also, as shown in FIG. 4, the air suction port 32b which is not connected to the extension duct 34 between the air suction ducts 32a and 32b is formed wider at upper side and narrower at the lower side. The air suction port 32b is positioned at the second half portion of the rear plate 32, that is, at the lower side than the extension duct 34. Accordingly, the amount of the air sucked to the drum 30 can be increased and the contactive distribution with clothes is increased, thus to improve drying efficiency.

Then, the air which was flown into the drum 30 through the air suction ports 32a and 32b and the extension duct 34 and dried clothes is exhausted to the outside of the case 10 through the air exhaust port 33a and exhaust duct 72 positioned at the opposite side of the air suction ports 32a and 32b or the extension duct 34.

Here, with reference to FIG. 5, in the clothes dryer in accordance with the second embodiment of the present invention, since the air exhaust port 133a is formed at the cylindrical portion 133a of the front plate 133, the space where the exhaust duct occupies at the front side centering round the drum 130 is removed and accordingly the whole volume of the drum 130 can be increased. Therefore, the amount of clothes drying can be increased without increasing the whole volume of the case.

Also, with reference to FIG. 7, in the clothes dryer in accordance with the third embodiment of the present invention, the exhaust duct 272 is divided into a plurality number and the first exhaust duct 272A is lengthened-formed to the outside of the case. Since the second exhaust duct 272B is lengthened to face the inlet side of the heater 260, part of the heated air passed through the drum 230 is re-circulated to the drum 230 through the heater 260 and the suction duct 271. Therefore, time for heating air in the heater 260 can be shortened and the suction amount of the air into the drum 230 is increased, thus to improve drying efficiency.

On the other hand, with reference to FIGS. 6 and 7, in the clothes dryer in accordance with the second embodiment of the present invention, since a first motor 241 for driving the drum 230 and a second motor 242 for driving the fan 273 are positioned, the first motor 241 and the second motor 242 can be controlled independently and the direction and speed of the rotation can be controlled differently, thus to reduce time for drying and improve drying efficiency.

For example, in case of the first drying, the second motor 242 is driven at high speed and then the clothes can be dried evenly by lowering the speed. Also, the first motor 241 can prevent the clothes from being tangled changing the rotation direction, thus to increase drying efficiency.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A clothes dryer, comprising:
a drum supported in the case rotatably, having a space for drying clothes inside;
a suction duct connected to one side of the drum, to which air for drying clothes is supplied;
an extension duct lengthened from the suction duct into the drum, for flowing the air supplied from the suction duct into the drum; and
an exhaust duct connected to the other side of the drum, for exhausting air which dried clothes to the outside of the case.

2. The dryer of claim 1, wherein the extension duct is lengthened-installed at the position of the rotation center of the drum in the longitudinal direction of the drum.

3. The dryer of claim 1, wherein the extension duct has an end portion lengthened to the center portion of the drum.

4. The dryer of claim 1, wherein the extension duct is formed in a cylindrical shape and a plurality of air holes are formed on the circumferential and end surfaces.

5. The dryer of claim 1, wherein the drum has two air suction ports connected to the suction duct on the rear side and the extension duct is connected to an air suction port between the two air suction ports.

6. The dryer of claim 5, wherein the air suction port which is not connected to the extension duct is formed a certain distance apart from the rotation center of the drum.

7. The dryer of claim 5, wherein the air suction port connected to the extension duct is positioned at the rotation center of the drum.

8. The dryer of claim 5, wherein the air suction port which is not connected to the extension duct is formed to have larger area along from the rotation center to the outer circumferential direction.

9. The dryer of claim 1, wherein the drum comprises a body which rotates formed in a cylindrical form, a front plate and a rear plate combined to the front and rear sides of the body, which does not rotate, an inlet portion of the exhaust duct is connected to the front plate and a suction duct and extension duct are connected to the rear plate ventilating with each other.

10. The dryer of claim 9, wherein the exhaust duct is connected at the front side of the front plate.

11. The dryer of claim 9, wherein the front plate has a cylindrical portion lengthened a certain length in the longitudinal direction of the body from the outer circumferential surface and the exhaust duct is connected to an exhaust port formed at the lower side of the cylindrical portion.

12. The dryer of claim 1, wherein the exhaust duct is composed so as to re-flow part of air exhausted from the inside of the drum into the drum through the suction duct.

13. The dryer of claim 1, wherein a heater for heating suction air is installed at the inlet portion of the suction duct and the exhaust duct discharges part of the air exhausted from the drum to the front side of the heater and re-flow the air into the drum.

14. The dryer of claim 1, wherein the exhaust duct comprises:
a first exhaust duct for exhausting air exhausted from the drum to the outside of the case; and
a second exhaust duct diverged from the first exhaust duct, for exhausting part of the air exhausted from the drum to the front side of the suction duct.

15. The dryer of claim 1, wherein a fan is installed to compulsorily flow air in the air circulative pass composed of the suction duct and exhaust duct and the fan and the drum are rotated and driven by a driving motor.

16. The dryer of claim 1, wherein a fan is installed to compulsorily flow air in the air circulative pass composed of the suction duct and exhaust duct and the fan and the drum are rotated and driven by each driving motor.

17. A clothes dryer, comprising:
a drum composed of a body supported rotatably in a case and a front plate and a rear plate combined to the front and rear sides of the body, which do not rotate;
a suction duct connected to the rear plate of the drum, to which air for drying clothes is supplied; and
an exhaust duct connected to the front plate of the drum, for exhausting air which dried clothes to the outside,
wherein the front plate of the said drum comprises a cylindrical portion lengthened a certain length in the longitudinal direction of the body from the outer circumferential surface, having an exhaust port at the lower portion, and the said exhaust duct is connected to the exhaust port of the cylindrical portion.

18. A clothes dryer, comprising:
a drum composed of a body supported rotatably in a case and a front plate and a rear plate combined to the front and rear sides of the body, which do not rotate;
a suction duct connected to the rear plate of the drum, to which air for drying clothes is supplied; and
an exhaust duct connected to the front plate of the drum, for exhausting air which dried clothes to the outside,
wherein an air suction port is formed on the rear plate of the said drum so that the suction duct is connected to the air suction port and, the air suction port is formed to have larger area along from the rotation center of the drum to the outer circumferential direction.

19. A clothes dryer, comprising:
a drum supported in the case rotatably, having a space for drying clothes inside;
a suction duct connected to one side of the drum, to which air for drying clothes is supplied;
a first exhaust duct connected to the other side of the drum for exhausting air which dried clothes to the outside of the case; and
a second exhaust duct diverged from the first exhaust duct, for exhausting part of the air exhausted from the drum to the front side of the suction duct.

20. The dryer of claim 19, wherein a heater for heating suction air is installed at the inlet portion of the suction duct and the exhaust duct re-flows a part of the air exhausted from the exhaust duct into the drum by exhausting the air into the front side of the heater.
